(19) United States
(12) Patent Application Publication
(10) Pub. No.: US 2019/0387583 A1
(43) Pub. Date: Dec. 19, 2019

(54) PTC HEATING MODULE

(71) Applicant: Mahle International GmbH, Stuttgart (DE)

(72) Inventors: Tim Teichmann, Karlsruhe (DE); Falk Viehrig, Stuttgart (DE)

(21) Appl. No.: 16/444,256

(22) Filed: Jun. 18, 2019

(30) Foreign Application Priority Data
Jun. 18, 2018 (DE) 10 2018 209 777.1

(51) Int. Cl. H05B 1/02; H05B 3/26

(52) U.S. Cl. CPC H05B 1/0297; H05B 2203/02; H05B 3/26

(57) ABSTRACT

A PTC heating module for heating a fluid may include at least one PTC thermistor having two flat main surfaces disposed opposite one another. The two main surfaces may be arranged parallel to and spaced apart from one another defining a thermistor thickness of the at least one PTC thermistor therebetween. The two main surfaces may be connected to one another by at least one lateral surface and the at least one PTC thermistor may be delimited toward an outside by the at least one lateral surface and the two main surfaces. The module may also include two contact plates between which the at least one PTC thermistor is arranged. A cross section of the at least one PTC thermistor defined perpendicularly to the two main surfaces may deviate from a rectangle such that a creep distance between the two main surfaces is greater than the thermistor thickness.

### CROSS-REFERENCE TO RELATED APPLICATIONS

This application claims priority to German Patent Application No. DE 10 2018 209 777.1, filed on Jun. 18, 2018, the contents of which is hereby incorporated by reference in its entirety.

### TECHNICAL FIELD

The invention relates to a PTC heating module for heating a fluid having at least one PTC thermistor.

### BACKGROUND

An electric heater for a hybrid or electric vehicle usually comprises multiple PTC heating modules (PTC: positive temperature coefficient) with multiple ceramic PTC thermistors. The thermistors have a temperature-dependent electrical resistance which increases with increasing temperature. Because of this, a temperature that varies only slightly is established on the PTC thermistors regardless of the peripheral conditions—such as for example voltage or nominal resistance. Because of this, overheating of the PTC thermistors can be advantageously prevented. The electric heater can be employed for example in order to maintain the temperature in the passenger cabin in the starting phase and while driving in cold ambient temperatures. Here, air, fresh air and/or circulating air is heated up either directly with the electric heater or indirectly by means of a heat exchanger. The heat exchanger is supplied with another fluid—for example coolant—which is heated with the electric heater and then passes the stored heat on to the air. Following this, the heated air is conducted to the passenger cab. In the passenger cab, the heated air can give off the stored heat and said passenger cab thereby heated. In the case of an electric vehicle, the electric heater generally also constitutes the only possibility for heating.

In a hybrid or electric vehicle, a PTC heating module is fed by the drive battery which currently provides a voltage between 150 V and 500 V. Voltages up to 800 V are even demanded for the future. A safe contact protection for protecting the occupants is therefore indispensible. In particular, all electrically conductive elements of the PTC heating module that can be touched from the outside have to be potential-free. For this purpose, the PTC thermistor is electrically insulated towards the outside by an electrical insulation, wherein the electrical insulation for discharging the heat is heat-conductive through the insulation.

Furthermore, for adhering to air and creep distances, the contact electrodes on the PTC thermistor have to be adequately spaced, wherein the distance of the two contact electrodes increases with the increasing voltage. In a conventional PTC heating module, the contact electrodes lie flat on the surface of the PTC thermistor, so that a distance between the contact electrodes corresponds to a thickness of the PTC thermistor. Accordingly, as the voltage increases, the thickness of the PTC thermistor have to be increased for adhering to air and creep distances in the PTC heating module. Accordingly, at a voltage of 400 V at the PTC heating module, the necessary distance of the two contact electrodes is approximately 2 mm. With a voltage of 800 V, the distance of the two contact electrodes would have to be increased to approximately 4 mm. Since however the ceramic PTC thermistors have a low heat conductivity, the heat, in the case of a greater thickness, can only be dissipated with difficulty from an inner region of the PTC thermistor. Accordingly, the temperature in the inner region of the PTC thermistor and its electrical resistance increase. Disadvantageously, the output of the PTC heating module drops because of this.

### SUMMARY

An object of the invention therefore is to state an improved or at least alternative embodiment for a PTC heating module of the generic type, with which the described disadvantages are overcome. In particular it is the object of the invention to adhere to standardised distances first for the creep distances without negatively influencing the output of the PTC heating module.

According to the invention, this object is solved through the subject of the independent claim(s). Advantageous embodiments are subject of the dependent claims.

The present invention is based on the general idea of increasing the creep distance in a PTC heating module through geometry of the PTC thermistor. A PTC heating module for heating a fluid comprises at least one PTC thermistor with two flat main surfaces located opposite one another. The two main surfaces are arranged parallel and spaced from one another and define a thermistor thickness of the PTC thermistor. The main surfaces of the PTC thermistor are connected to one another by at least one lateral surface and the PTC thermistor is delimited towards the outside by the at least one lateral surface and the main surfaces. Furthermore, the PTC heating module comprises two contact plates between which the PTC thermistor is arranged. According to the invention, a cross section of the PTC thermistor defined perpendicularly to the main surfaces of the PTC thermistor deviates from a rectangle so that a creep distance between the two main surfaces of the PTC thermistor is greater than the thermistor thickness of the PTC thermistor. Here, the creep distance is defined by the shortest distance of the main surfaces of the PTC thermistor along the at least one lateral surface of the PTC thermistor.

The cross section of the PTC thermistor according to the invention deviates from a rectangle. The two main surfaces of the PTC thermistor are parallel to one another so that the form of the cross section deviating from a rectangle is defined by the at least one lateral surface of the PTC thermistor. The creep distance along the at least one lateral surface in the PTC heating module according to the invention accordingly does not correspond to the shortest distance between the two main surfaces and is enlarged. The creep distance in this case depends on the configuration of the at least one lateral surface and can be adapted to the specified voltage independently of the thermistor thickness. Advantageously, the creep distance can be for example 110% to 500% of the thermistor thickness of the respective PTC thermistor. Accordingly, the thermistor thickness can be selected independently on the creep distance demanded for the specified voltage and the output of the PTC heating module dependent on the thermistor thickness be optimised.

In the PTC thermistor, a current flow direction between the two contact plates with the applied voltage substantially corresponds to a heat flow direction between the two main surfaces. “Substantially” in this connection means that the current flow direction deviates from the heat flow direction by maximally 20%. Practically, the contact plates are thermally and electrically conductive so that through the contact plates the specified voltage can be applied to the respective PTC thermistor and the heat generated in the at least one PTC thermistor be effectively given off to the outside via the contact plates. The contact plates can consist for example of aluminium. Advantageously it can be provided that the respective main surfaces are coated with a contacting layer over the entire surface. The respective contact plate in this case can lie against the respective contacting layer with the entire surface. The contacting layer can be for example a silver or an aluminium coating. In order to increase the output of the PTC heating module, the PTC heating module can advantageously comprise multiple PTC thermistors which are arranged next to one another between the two contact plates. The respective PTC thermistors can be arranged both in a row next to one another or in multiple rows and in multiple columns next to one another to form a two-dimensional matrix.

Advantageously it can be provided that a surface of the PTC thermistor through which electric current flows changes from the one main surface to the other main surface. In the PTC heating module according to the invention, the at least one PTC thermistor is arranged between the two contact plates and the electric current consequently flows from the one contact plate to the other contact plate via the at least one PTC thermistor. The surface of the at least one PTC thermistor through which the electric current flows is consequently parallel to the contact plates of the PTC heating module. Dependent on the cross section of the PTC thermistor, the surface of the PTC thermistor through which the electric current flows can change continuously or suddenly.

In an advantageous further development of the PTC heating module according to the invention it is provided that the at least one lateral surface has a cutting angle relative to the respective main surface which deviates from 90°, so that the cross section of the at least one PTC thermistor does not correspond to a rectangular trapezium. Here, the cross section can correspond to an isosceles trapezium or a non-isosceles trapezium. The creep distance defined in this case by a leg length of the trapezium is greater than the thermistor thickness defined in this case by a height of the trapezium. If the trapezium is a parallelogram, the surface of the PTC thermistor through which the electric current flows does not change. In all other cases, the surface of the PTC thermistor through which the current flows continuously decreases or increases from the one main surface to the other main surface.

In a further advantageous further development of the PTC heating module according to the invention it is provided that the at least one lateral surface consists of multiple part surfaces each of which are arranged at a cutting angle relative to one another that deviates from zero. The part surfaces can be both level or curved. The cross section of the PTC thermistor then corresponds to a concave or a convex polygon with more than four corners.

The creep distance defined in this case by a totalised length of the part surfaces is greater than the thermistor thickness defined in this case by a height of the polygon. If the polygon is concave, the surface of the PTC thermistor through which the electric current flows continuously decreases from the one main surface to the other main surface and continuously increases thereafter. In the case of a convex quadrangle, the surface of the PTC thermistor through which the electric current flows initially increases continuously from the one main surface to the other main surface and continuously decreases thereafter.

In a further advantageous further development of the PTC heating module according to the invention it is provided that the at least one lateral surface has one or multiple step-like mouldings or protrusions. The cross section of the PTC thermistor then corresponds to a concave polygon with more than four corners. The polygon can have straight or curved edges. Here, the surface of the PTC thermistor through which the electric current flows from the one main surface to the other main surface suddenly increases and/or suddenly decreases.

Advantageously it can be provided that the PTC thermistor is in one piece or monolithical. The one-piece of monolithical PTC thermistor can be pressed for example in a press mould in a pressing method in order to form the PTC thermistor with the cross section deviating from a rectangle. Alternatively, the corresponding cross section can be produced on the PTC thermistor by a processing method.

Alternatively it can be provided that the PTC thermistor is formed from multiple PTC elements which are stacked against one another with a stacking surface in each case. Between each of the multiple PTC elements stacked against one another, an electrically and thermally conductive coating can be fixed. So as not to reduce the size of the creep distance between the main surfaces of the PTC thermistor by the electrically conductive coating, the coating can cover the stacking surface of the respective PTC element over the entire or part surface. Accordingly, the coating, in its dimensions, can correspond for example to the smallest stacking surface of the two PTC elements lying against one another. The receptive PTC elements stacked against one another then form the PTC thermistor with the cross section deviating from a rectangle. By way of the PTC elements stacked against one another, producing the PTC thermistor with a complex cross section can be simplified.

In summary, the creep distance between the two main surfaces in the PTC heating module is adaptable through the cross section of the at least one PTC thermistor independently of the thermistor thickness. The thermistor thickness of the at least one PTC thermistor is thus independent of the specified voltage so that the output of the PTC heating module can be optimised through the adapted thermistor thickness.

Further important features and advantageous of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF THE DRAWINGS

It shows, in each case schematically

FIG. 1 a sectional view of a PTC heating module according to the invention;

FIG. 2 an exploded view of contact plates and of PTC thermistors arranged between the contact plates in the PTC heating module from FIG. 1;

FIGS. 3 to 20 views of differently configured PTC thermistors in the PTC heating module according to the invention.

### DETAILED DESCRIPTION

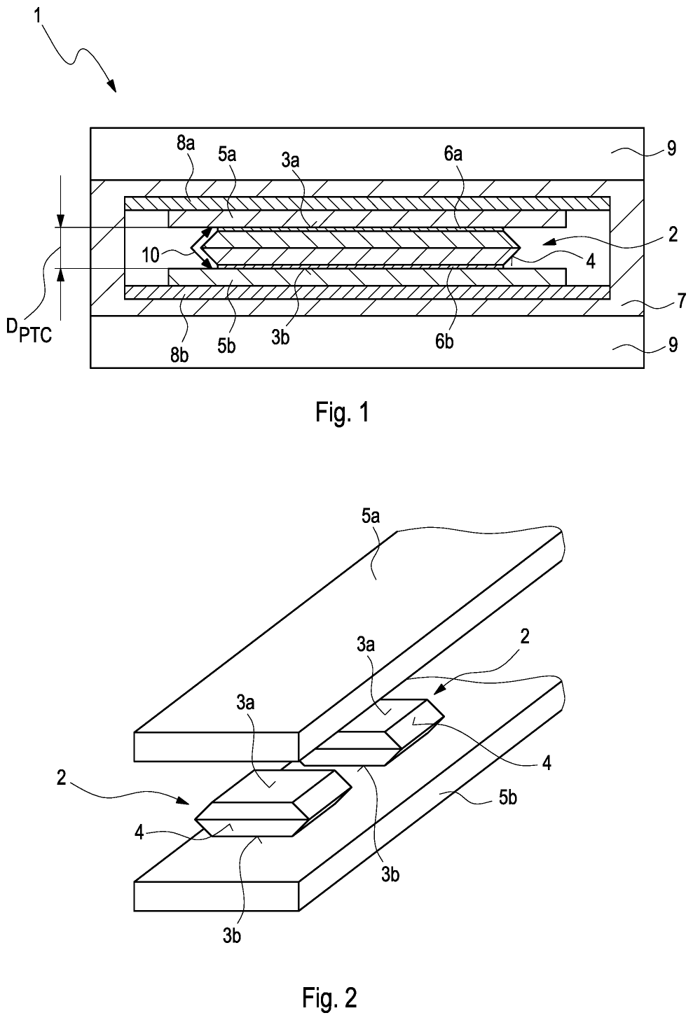

FIG. 1 shows a sectional view of a PTC heating module 1 according to the invention for heating a fluid. The PTC heating module 1 comprises multiple PTC thermistors 2 each with two flat main surfaces 3a and 3b located opposite one another. The two main surfaces 3a and 3b are arranged parallel to and spaced from one another and define a thermistor thickness D_{PTC} of the respective PTC thermistor 2. The main surfaces 3a and 3b of the respective PTC thermistor 2 are, furthermore, connected to one another by lateral surfaces 4 and the PTC thermistor 2 is delimited to the outside by the lateral surfaces 4 and the main surfaces 3a and 3b. The PTC heating module 1, furthermore, comprises two contact plates 5a and 5b between which the respective PTC thermistor 2 is arranged. Between the respective contact plate 5a and 5b and the respective main surface 3a and 3b of the respective PTC thermistor 2, an electrically and thermally conductive contacting layer 6a and 6b is arranged in each case. In FIG. 2, an exploded view of the contact plates 5a and 5b and the multiple PTC thermistors 2 in the PTC heating module 1 is shown.

The respective PTC thermistors 2 are arranged next to one another between the two contact plates 5a and 5b and contacted to these in an electrically and thermally conductive manner via the respective contacting layers 6a and 6b. In the respective PTC thermistor 2, a current flow direction between the two contact plates 5a and 5b with the applied voltage substantially corresponds to a heat flow direction between the two main surfaces 3a and 3b. The contact plates 5a and 5b with the respective PTC thermistor 2 are arranged in a housing 7, wherein the contact plates 5a and 5b are separated from the housing 7 in each case by an electrically insulating and thermally conductive insulating layer 8a and 8b. On the one hand, the heat generated in the respective PTC thermistor 2 can be discharged via the contact plates 5a and 5b and via the insulating layers 8a and 8b to the housing 7 and further to the outside and on the other hand the housing 7 can be electrically insulated toward the outside. Furthermore, a rib structure 9 is fixed to the housing 7 in a thermally conductive manner which is provided for the effective dissipation of the heat from the housing 7 to the fluid circulating about the rib structure 9.

The PTC thermistor 2 has a cross section that deviates from a rectangle. Because of this, a creep distance 10 between the two main surfaces 3a and 3b is greater than the thermistor thickness D_{PTC} of the PTC thermistor 2. The creep distance 10 in this case is defined by the shortest distance of the main surfaces 3a and 3b of the PTC thermistor 2 along the respective lateral surface 4 of the PTC thermistor 2. Through the geometry of the PTC thermistor 2, the thermistor thickness D_{PTC} is independent of the creep distance 10 demanded for the specified voltage so that the output of the PTC heating module 1 is optimisable independently of the thermistor thickness D_{PTC}.

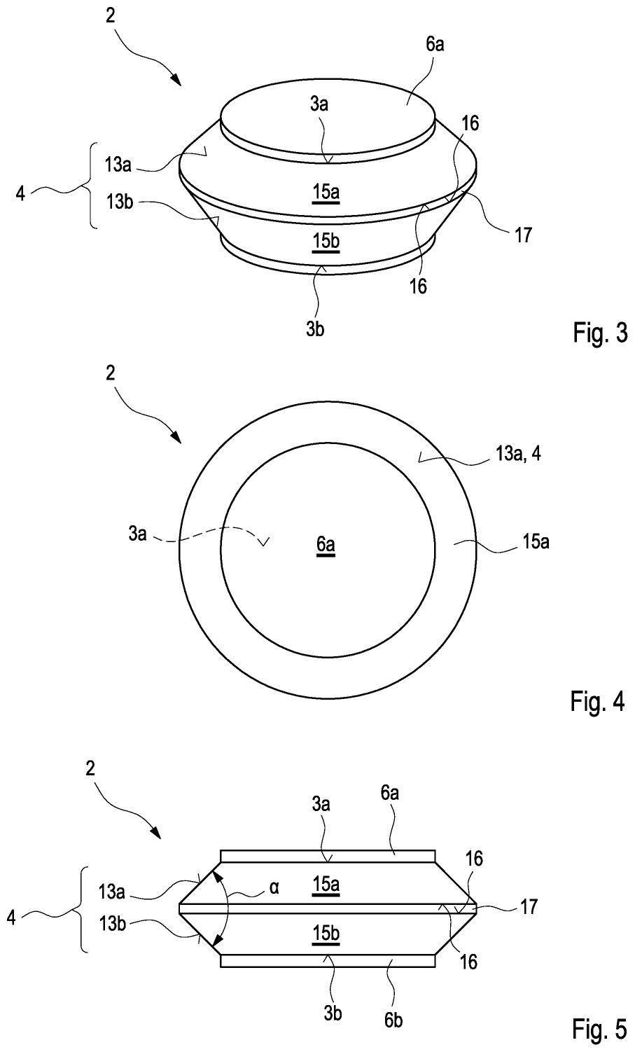

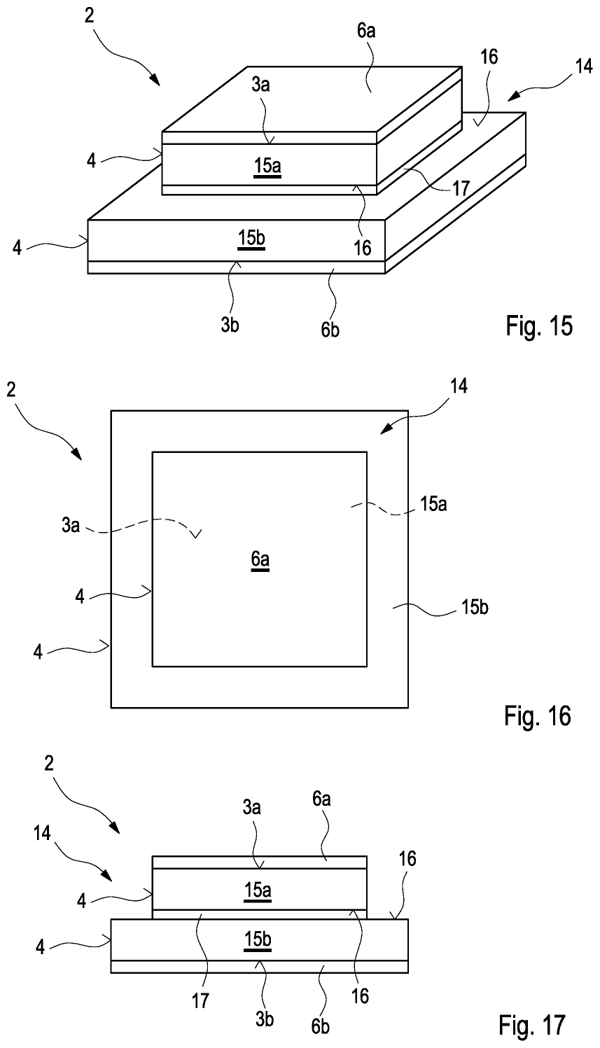

Views of the differently configured PTC thermistor 2 are shown in FIG. 3 to FIG. 20. Independently of their configuration, the shown PTC thermistors 2 are constructed of multiple PTC elements 15a and 15b each of which have a stacking surface 16. Between the respective PTC elements 15a and 15b that are stacked against one another, an electrically and thermally conductive coating 17 each is arranged, wherein the coating 17 in its dimensions corresponds to the smallest stacking surface 16 of the two PTC elements 15a and 15b lying against one another. In particular in the PTC thermistors 2 according to FIG. 15 to FIG. 20, a shortening of the creep distance 10 can thereby be prevented. The respective main surfaces 3a and 3b of the shown PTC thermistors 2 are coated over the entire surface with the respective contacting layers 9a and 9b. Alternatively to the examples shown here, the PTC thermistors 2 in FIG. 3 to FIG. 20 can also be in one piece or monolithical regardless of their configuration. Deviating from the shown examples, the respective PTC elements 15a and 15b, furthermore, can also be stacked against one another without a coating 17.

In FIG. 3 to FIG. 5, views of the PTC thermistor 2 are shown which is designed rotation-symmetrically. The respective lateral surface 4 in this case is formed from two flat part surfaces 13a and 13b which are each arranged at a cutting angle a relative to one another that deviates from zero. The cross section of the PTC thermistor 2 in this case corresponds to a convex hexagon.

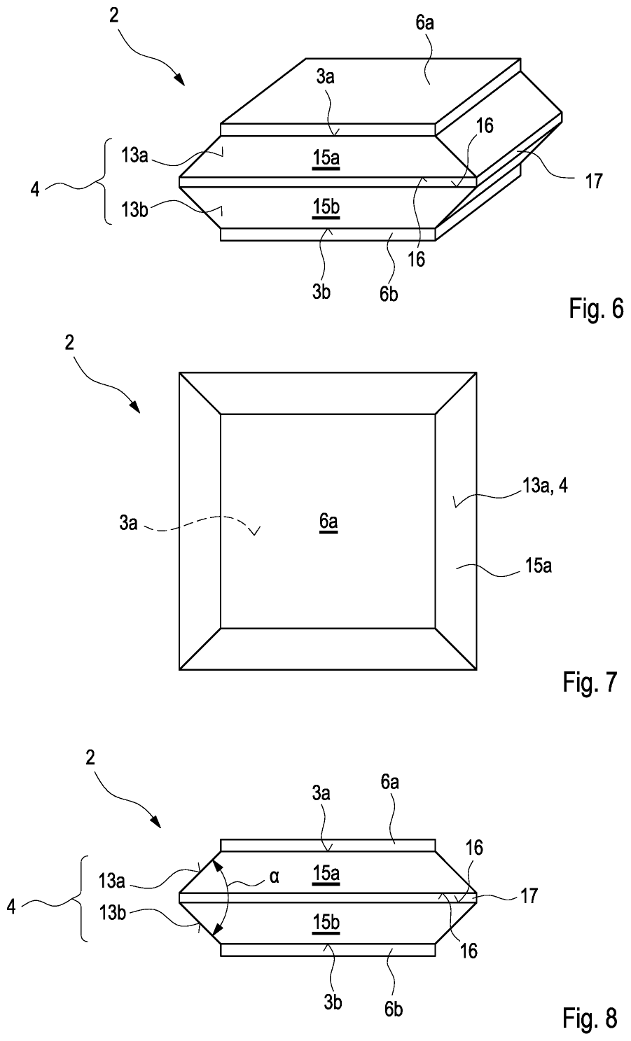

In FIG. 6 to FIG. 8, views of the PTC thermistor 2 are shown which has square main surfaces 3a and 3b. The respective lateral surfaces 4 in this case are each formed from two flat part surfaces 13a and 13b which are each relative to one another at a cutting angle deviating from zero. The cross section of the PTC thermistor 2 in this case corresponds to a convex hexagon.

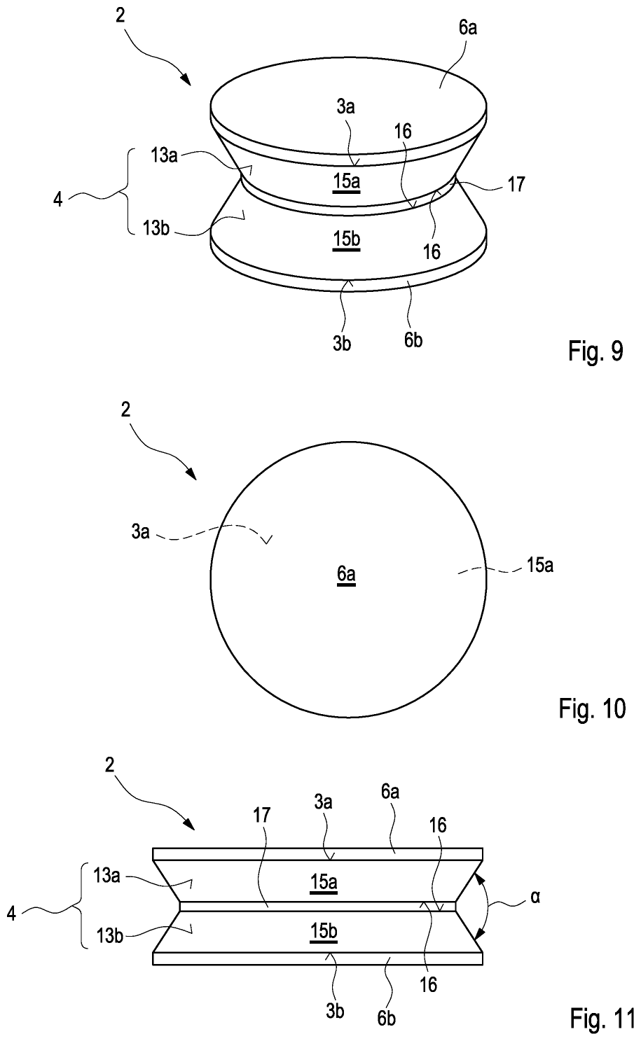

In FIG. 9 to FIG. 11, views of the PTC thermistor 2 are shown which is designed rotation-symmetrical. The respective lateral surface 4 in this case is formed from two flat part surfaces 13a and 13b each of which are arranged relative to one another at a cutting angle a deviating from zero. The cross section of the PTC thermistor 2 in this case corresponds to a concave hexagon.

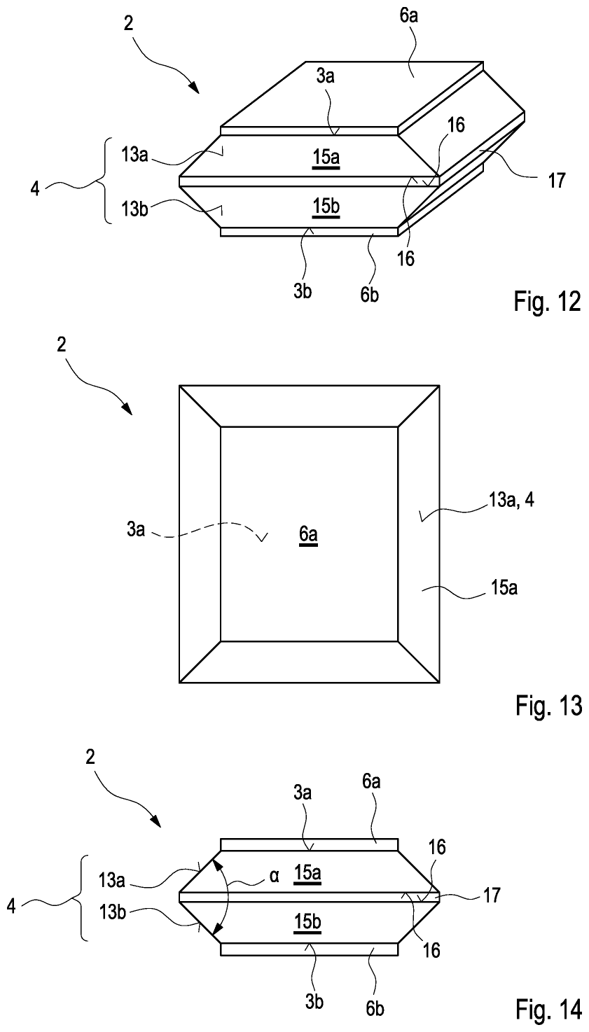

In FIG. 12 to FIG. 14, views of the PTC thermistor 2 are shown which has rectangular main surfaces 3a and 3b. The respective lateral surfaces 4 in this case are each formed from two flat part surfaces 13a and 13b which are arranged relative to one another at a cutting angle a deviating from zero. The cross section of the PTC thermistor 2 in this case corresponds to a concave hexagon.

In FIG. 15 to FIG. 17, views of the PTC thermistor 2 are shown which has square main surfaces 3a and 3b. The respective lateral surfaces 4 in this case each have a stepped moulding 14. The cross section of the PTC thermistor 2 in this case corresponds to a convex octagon.

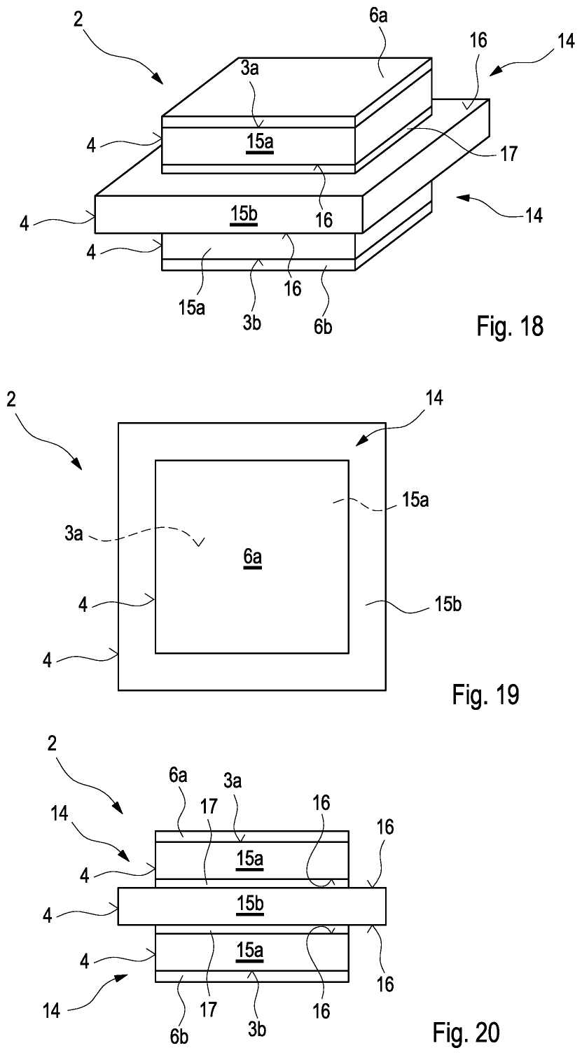

In FIG. 18 to FIG. 20, views of the PTC thermistor 2 are shown which has square main surfaces 3a and 3b and a step-like moulding 14 arranged in the middle. The cross section of the PTC thermistor 2 in this case corresponds to a convex dodecagon.

In summary, the creep distance 10 in the PTC heating module 1 between the two main surfaces 3a and 3b is adaptable by the cross section of the PTC thermistor 2 independently of the thermistor thickness D_{PTC}. The air gap 10b between the contact plates 5a and 5b can also be adapted independently of the thermistor thickness D_{PTC}. The thermistor thickness D_{PTC} of the respective PTC thermistor 2 is thereby independent of the specified voltage so that the output of the PTC heating module 1 can be optimised through the adapted thermistor thickness D_{PTC}.

1. A PTC heating module for heating a fluid, comprising:
at least one PTC thermistor having two flat main surfaces disposed opposite one another;
the two main surfaces arranged parallel to and spaced apart from one another defining a thermistor thickness of the at least one PTC thermistor therebetween;
the two main surfaces connected to one another by at least one lateral surface and the at least one PTC thermistor delimited toward an outside by the at least one lateral surface and the two main surfaces;
two contact plates between which the at least one PTC thermistor is arranged
wherein a cross section of the at least one PTC thermistor defined perpendicularly to the two main surfaces deviates from a rectangle such that a creep distance between the two main surfaces is greater than the thermistor thickness.

2. The PTC heating module according to claim 1, wherein the at least one lateral surface has a cutting angle relative to a respective main surface of the two main surfaces that deviates from 90° such that the cross section of the at least one PTC thermistor corresponds to a non-rectangular trapezium.

3. The PTC heating module according to claim 1, wherein the at least one lateral surface is defined by a plurality of surfaces each arranged relative to one another at a cutting angle that deviates from zero such that the cross section of the at least one PTC thermistor corresponds to one of a concave polygon and a convex polygon with more than four corners.

4. The PTC heating module according to claim 1, wherein the at least one lateral surface includes at least one step-like moulding.

5. The PTC heating module according to claim 1, wherein the at least one PTC thermistor is at least one of provided as a single piece and monolithical.

6. The PTC heating module according to claim 1, wherein the at least one PTC thermistor is defined by a plurality of PTC elements stacked against one another with a stacking surface.

7. The PTC heating module according to claim 6, further comprising, disposed between each of the plurality of PTC elements stacked against one another, an electrically and thermally conductive coating, wherein the coating at least partially covers the stacking surface of each of the plurality of PTC elements.

8. The PTC heating module according to claim 1, wherein:
in that each of the two main surfaces have a contacting layer extending over an entire surface; and
each of the two contact plates lies against the contacting layer of one of the two main surfaces with an entire surface.

9. The PTC heating module according to claim 1, wherein a surface of the at least one PTC thermistor through which electric current flows changes from one of the two contact plates to the other of the two contact plates.

10. The PTC heating module according to claim 1, wherein, in the at least one PTC thermistor, a current flow direction between the two contact plates substantially corresponds to a heat flow direction between the two main surfaces.

11. The PTC heating module according to claim 1, wherein the at least one PTC thermistor includes a plurality of PTC thermistors arranged next to one another between the two contact plates.

12. The PTC heating module according to claim 1, wherein the at least one lateral surface is defined by a plurality of surfaces extending transversely to one another and the two main surfaces such that the cross section of the at least one PTC thermistor is shaped as a concave polygon having more than four corners.

13. The PTC heating module according to claim 1, wherein the at least one lateral surface is defined by a plurality of surfaces extending transversely to one another and the two main surfaces such that the cross section of the at least one PTC thermistor is shaped as a convex polygon with more than four corners.

14. A PTC heating module for heating a fluid, comprising:
a plurality of PTC thermistors each having and delimited by two flat main surfaces connected by at least one lateral surface, the two flat main surfaces extending parallel to one another and disposed opposite one another defining a thermistor thickness therebetween;
two contact plates between which the plurality of PTC thermistors are arranged next to one another;
a contacting layer of a plurality of contacting layers extending along an entirety of each of the two main surfaces of each of the plurality of PTC thermistors, the two contacting plates lying against the plurality of contacting layers;
wherein each of the plurality of PTC thermistors has a cross section defined perpendicularly to the two main surfaces which deviates from a rectangular shape such that a creep distance between the two main surfaces is greater than the thermistor thickness.

15. The PTC heating module according to claim 14, wherein a current flow direction between the two contact plates substantially corresponds to a heat flow direction between the two main surfaces of each of the plurality of PTC thermistors.

16. A PTC heating module for heating a fluid, comprising:
a plurality of PTC thermistors each having and delimited by two flat main surfaces connected by a plurality of lateral surfaces, the two flat main surfaces extending parallel to one another and disposed opposite one another defining a thermistor thickness therebetween;
each of the plurality of PTC thermistors defined by a plurality of PTC elements each having at least one stacking surface, the plurality of PTC elements stacked on top of one another via the at least one stacking surface;
two contact plates between which the plurality of PTC thermistors are arranged next to one another;
wherein a cross section of each of the plurality of PTC thermistors defined perpendicularly to the two main surfaces deviates from a rectangular shape such that a creep distance between the two main surfaces is greater than the thermistor thickness.

17. The PTC heating module according to claim 16, wherein the plurality of lateral surfaces extend transversely to each of the two main surfaces at a non-right angle.

18. The PTC heating module according to claim 17, wherein the two main surfaces are connected by at least two adjacent lateral surfaces of the plurality of lateral surfaces adjoining one another between the two main surfaces, the at least two adjacent lateral surfaces extending transversely to one another by a cutting angle such that the cross section of the at least one PTC thermistor is shaped as one of a concave polygon with more than four corners and a convex polygon with more than four corners.

19. The PTC heating module according to claim 16, wherein an electrically and thermally conductive coating is disposed on and covers an entirety of the at least one stacking surface of each of the plurality of PTC elements.

20. The PTC heating module according to claim 16, wherein at least one of the plurality of lateral surfaces includes at least one step-like moulding.
